(19) United States
(12) Patent Application Publication
(10) Pub. No.: US 2005/0118494 A1
(43) Pub. Date: Jun. 2, 2005

(54) Implantable biofuel cell system based on nanostructures

(76) Inventor: Sung Hoi Choi, Canyon Country, CA (US)

Correspondence Address: Douglas N. Larson;Squire, Sanders & Dempsey, L.L.P., 14th Floor, 801 S. Figueroa Street, Los Angeles, CA, 90017, US

(21) Appl. No.: 10/726,261

(22) Filed: Dec. 1, 2003

(51) Int. Cl. H01M 4/90; H01M 8/20; H01M 4/96; H01M 4/88

(52) U.S. Cl. 429/43; 429/105; 429/44; 502/101

(57) ABSTRACT

A bio-implantable electrochemical cell system for active implantable medical devices. In one embodiment, the fuel cell includes an electrode structure consisting of immobilized anode and cathode enzymes deposited on nanostructured high-surface-area metal nanowires or carbon nanotube electrodes. The anode enzyme comprises immobilized glucose oxidase and the cathode enzyme comprises immobilized laccase. Glucose is oxidized at the surface of the anode and oxygen is reduced at the surface of the cathode. The coupled glucose oxidation-oxygen reduction reactions provide a self-generating current source. In another embodiment, the nanowires or carbon nanotubes, along with the adjacent surface anode and cathode electrodes, are coated with immobilized glucose oxidase and immobilized laccase containing biocolloidal substrates, respectively. This results in the precise construction of an enzyme architecture with control at the molecular level, while increasing the reactive surface area and corresponding output power by at least two orders of magnitude.

### BACKGROUND OF THE INVENTION

1. Field of the Invention

The present invention relates to implantable power sources, and more particularly to a bio-implantable electrochemical cell system for providing high power for active implantable medical devices.

2. Description of the Prior Art

Implantable power sources for cardiac pacemakers, defibrillators, implantable diffusion pumps, neurostimulators and other active implantable medical devices have contributed to the health of millions of patients during the past few decades. During this same period, there have been increasing pressures to reduce healthcare costs by reducing hospital and in-patient stays without compromising the quality of patient care. The result has been an increase in the numbers of out-patients who rely on active implantable medical devices to maintain and/or improve their health.

An active implantable medical device is defined as any active device which is intended to be totally or partially introduced, surgically or medically, into the human body or by medical intervention into a natural orifice, and which is intended to remain after the procedure.

For example, a cardiac pacemaker is an active implantable medical device that uses a steady electrical pulse to regulate the beating of the human heart. The first cardiac pacemaker was invented by John Hopps in 1950, but this device was far too large to be implanted inside the human body. The first implantable cardiac pacemaker and corrosion-free lithium battery was invented by Wilson Greatbatch in the late 1950's (U.S. Pat. No. 3,057,356 issued Oct. 9, 1962).

The cardiac pacemaker is implanted in the chest cavity, near the heart, and is used to correct slow ventricular rate (bradycardia), high ventricular rate (atrial fibrillation or flutter), and arrhythmia. Patients having these heart pacing abnormalities have a defective sinoatrial node and are unable to maintain a regular heartbeat. Modern cardiac pacemakers control both the ventricles and the atria of the heart, by timing the contraction of the atria to proceed that of the ventricles, thereby improving the pumping efficiency of the heart. These devices are particularly useful for patients suffering from congestive heart failure.

All cardiac pacemakers require a source of electrical power to function. Most cardiac pacemakers use implantable lithium batteries that are implanted with the pacemaker; however, they have the disadvantage of requiring an additional surgery every 24 months to replace the battery. The power requirements of the cardiac pacemaker are typically in the microampere range.

By contrast, the coronary stent is an example of a passive implantable medical device. A coronary stent consists of metal wires, usually stainless steel, nitinol or other metal alloy, that is used to remove blockage of coronary arteries. The stent is wrapped around a deflated balloon and surgically advanced to the site of the coronary artery blockage. The balloon is then inflated and the stent expands, pressing the blockage tissue against the wall of the artery and restoring the blood flow to the heart. In this procedure, called balloon angioplasty, there is no power source required for insertion of the coronary stent.

Another example of an active implantable medical device is the implantable drug infusion pump, which delivers therapeutic plasma levels of an active drug to a target organ or body compartment for prolonged periods of time. There exist both programmable and non-programmable drug infusion pumps. In the former the bulk drug flow is generated by direct mechanical action powered by a battery, while in the latter the flow is generated by a fluorocarbon propellant. The pump is surgically implanted in a subcutaneous pocket and connects to a dedicated catheter that has been placed in the appropriate compartment. Constant or variable rates of infusion are possible over long periods of time with minimal human intervention; however, in the case of programmable drug infusion pumps, the battery must eventually be replaced. The power requirements of the implantable drug infusion pump are typically in the milliampere range.

An example of an implantable drug infusion pump is the implantable insulin pump used to deliver insulin into patients with diabetes, in order to maintain their blood sugar, or glucose, at a constant level.

Most active implantable medical devices have been powered primarily by lithium/iodine or lithium/carbon monoflouride batteries. Lithium/iodine batteries are typically used to generate currents in the microampere range, while lithium/carbon monoflouride batteries can generate currents in the milliampere range. During the last few decades, the size of active implantable medical devices and the power consumption of their complementary metal-oxide semiconductor (CMOS) electronic circuits have been continually reduced. At the same time, the size and weight of the power sources for these devices have not been proportionally reduced, primarily due to the difficulty of miniaturizing the case and seal of the power source. At the same time, the case and seal are necessary for a battery since the lithium anode will oxidize in a humid environment, and the alkakine electrolyte of zinc-silver oxide batteries is highly corrosive.

As mentioned above, another difficulty with batteries as a power source for active implantable medical devices is the requirement of periodic recharging or replacement. This is particularly difficult in situations where the battery is contained within the implanted device, because surgery is required to remove and replace the battery. The alternative of having the power source located outside the body is equally problematic, since the point where the power leads enter the body is also subject to infection. Any situation in which an invasive procedure is used can lead to infection and other more serious medical complications.

The power requirements of different implantable devices vary from microamperes for cardiac pacemakers to milliamperes for drug infusion pumps and neurostimulators to amperes for cardiac defibrillators. These increasing power requirements lead directly to an increasing size and weight in power source that makes implanting of the latter impossible.

In addition to the above-discussed existing active implantable medical devices, the nascent fields of nanotechnology and nanomedicine are focused on developing and deploying implantable, molecular-scale machines and devices for the prevention and treatment of disease in the human body. For example, the most elemental nanomedical devices will be used to diagnose illness by monitoring the internal chemistry of the body. Currently under development by many researchers are mobile nanorobots, equipped with wireless transmitters, that might circulate in the blood and lymph systems and send out warnings when chemical imbalances occur or worsen. Similarly, fixed nanomachines may be implanted in the nervous system to monitor pulse, brain wave activity, and other neurological functions.

A more advanced use of nanotechnology in medicine might be the use of implanted, molecular-sized devices to dispense drugs or hormones at the cellular level. Ultimately artificial antibodies, artificial red and white blood cells, and antiviral nanorobots might be developed and deployed.

The most advanced nanomedicine might involve the use of nanorobots as miniature surgeons. The active implanted devices might repair damaged cells; or get inside of cells to replace or assist damaged intracellular structures. At the extreme, nanomachines might replicate themselves or correct genetic deficiencies by altering or replacing DNA molecules.

Most of these new nanotechnology devices will be active implantable devices that will require a miniature, implantable power source that does not need to be recharged or otherwise maintained.

Accordingly, there is a need for a bio-implantable electrochemical cell that derives its power from blood or other body fluids, has no mechanical or moving parts, has no hazardous electrolytes requiring a sealed case, is biologically compatible, and does not require external recharging or replenishment.

### SUMMARY OF THE INVENTION

The present invention is directed to a bio-implantable electrochemical cell system for providing high power for active implantable medical devices. The electrochemical cell of the present invention provides an order of magnitude improvement in power density (1,000 to 10,000 μW cm⁻²) over existing glucose/oxygen fuel cells, with a total output power of 1,000 to 10,000 μW. The output of the present invention is sufficient to power many conventional active implantable medical devices, including cardiac pacemakers, neurostimulators, and drug infusion pumps.

In a first embodiment of the present invention, the electrochemical cell includes a novel electrode structure consisting of immobilized anode and cathode enzymes deposited on nanostructured high-surface-area gold electrodes. The anode enzyme may comprise immobilized glucose oxidase and the cathode enzyme may comprise immobilized laccase. Glucose is oxidized in a half-reaction at the surface of the anode electrode by the glucose oxidase to form gluconolactone, plus two hydrogen ions (protons) and two electrons. Oxygen plus four hydrogen ions and four electrons are reduced in a half-reaction at the surface of the cathode electrode by the laccase to form two water molecules. The coupled glucose oxidation-oxygen reduction half-reactions provide an efficient, stable, and self-generating current source.

The nanostructured high-surface-area gold electrodes are formed on silicon or aluminum substrates to form the anode and cathode. In the first embodiment of the present invention, the electrodes are fabricated using a conventional template process in which the pores of an anodized alumina template are filled with gold by electrodeposition. The alumina template is formed by sputtering or evaporating a thin seed layer of gold followed by a layer of aluminum on a silicon, glass or aluminum substrate. The aluminum substrate is then electro-polished to remove surface defects and anodized which generates the pores and converts the aluminum to alumina. The size of the alumina template pores is controlled by adjusting the anodizing parameters, including the solution composition, operating temperature, and applied voltage.

After the pores have been formed and widened by the anodizing process, gold nanowires are formed in each of the pores by conventional electrodeposition. As mentioned above, the precise number and size of the pores, and therefore the precise number of nanowires that are fabricated depends on the careful control of the anodizing parameters. Once the pores have been filled with gold via the electrodeposition process, the anodized alumina template is chemically dissolved, leaving an array of nanostructured gold electrodes bonded to the silicon, aluminum or glass substrate.

The above template process results in an electrode having typical dimensions of 4 μM² and containing an array of approximately 1600 gold nanowires, with the exact number determined by the parameters of the anodizing process. In the first preferred embodiment fabricated according to the present invention, the estimated active reacting surface of each electrode is approximately 680 cm² compared to a flat surface area of 0.78 cm².

After the anodized alumina template is chemically dissolved, the gold nanowires and adjacent surface anode and cathode electrodes are coated with immobilized glucose oxidase and immobilized laccase, respectively, using a conventional Langmuir-Blodgett lift-off process. Using this process, one or more thin layers of immobilized enzyme are deposited onto the nanowires and adjacent surface of each electrode, resulting in the precise construction of enzyme architectures with control at the molecular level. In the present invention, the enzyme activity of both the glucose oxidase and laccase are improved using a pyrroloquinoline quinone (PQQ) mediated glucose oxidase system for the anode, with a tree-derived laccase for oxygen reduction at the cathode.

In the first embodiment of the present invention, a single electrochemical cell is formed from an anode and a cathode fitted in a bio-compatible housing with a porous membrane. The porous membrane excludes macromolecules and other constituents of the plasma from the interior of the fuel cell, while being permeable to glucose, oxygen, water and ions. The glucose and water molecules are therefore able to flow into the interior of the fuel cell to react with the immobilized enzymes of the anode and cathode, respectively. The anode and cathode are separated by an insulator of, for example, silicon dioxide, thereby allowing the electrons to accumulate on the cathode and positive charges to accumulate on the anode.

The amount of steady-state current generated by the electrochemical cell of the present invention is a function of the steady-state reaction rates of the oxidation and reduction processes. The reaction rates, in turn, depend primarily on the total reactive surface area of the anode and cathodes and the concentration of glucose and oxygen inside the cell. In the preferred embodiment, the total available power generated by the electrochemical cell ranges from 1000 μW to 10,000 μW.

In a second embodiment of the present invention, the novel electrode structure of the electrochemical cell consists of immobilized enzyme on nanostructured high-surface-area carbon nanotube electrodes. The nanostructured high-surface-area carbon nanotube electrodes are also formed on silicon or aluminum substrates to form the anode and cathode. The electrodes are fabricated using the above anodized alumina template process, but in this case the carbon nanotubes are formed inside the pores by chemical vapor deposition.

In accordance with the second embodiment of the present invention, the alumina template is again formed by sputtering or evaporating a thin seed layer of gold followed by a layer of aluminum on a silicon, glass or aluminum substrate. The aluminum substrate is then electro-polished to remove surface defects and anodized which generates the pores and converts the aluminum to alumina. As discussed in connection with the first embodiment of the present invention, the size of the alumina template pores is controlled by adjusting the anodizing parameters, including the solution composition, operating temperature, and applied voltage.

After the pores have been formed and widened by the anodizing process, a thin catalyst layer of nickel, iron, or cobalt is formed in each of the pores by electrodeposition. As mentioned above, the precise number and size of the pores, and therefore the precise number of carbon nanotubes that are fabricated depends on the careful control of the anodizing parameters. Once the pores have been filled with the catalyst, carbon nanotubes are grown in each pore, again using chemical vapor deposition. After the carbon nanotubes have been formed, the anodized alumina template is chemically dissolved, leaving an array of carbon nanotubes bonded to the silicon, aluminum or glass substrate.

The above template process results in an electrode having typical dimensions of 4 μM² and containing an array of approximately 1600 carbon nanotubes, with the exact number determined by the parameters of the anodizing process as previously described. In the second preferred embodiment fabricated according to the present invention, the estimated active reacting surface of each electrode is again approximately 680 cm² compared to a flat surface area of 0.78 cm², with the advantage of the superior tensile strength, conductivity, chemical inertness and biocompatibility of carbon.

After the anodized alumina template is chemically dissolved, the carbon nanotubes and adjacent surface anode and cathode electrodes are coated with immobilized glucose oxidase and immobilized laccase, respectively, using a conventional Langmuir-Blodgett lift-off process as described in connection with the first embodiment of the present invention.

A single electrochemical cell is then fabricated from an anode and a cathode fitted in a bio-compatible housing with a porous membrane. The amount of steady-state current generated by the electrochemical cell of the second embodiment of the present invention is again a function of the steady-state reaction rates of the oxidation and reduction processes. The reaction rates, in turn, depend primarily on the total reactive surface area of the anode and cathodes and the concentration of glucose and oxygen inside the cell, both of which are the same as for the gold nanowire-based electrodes of the first embodiment described herein.

A third embodiment of the present invention is similar to the first embodiment, except that the novel electrode structure consists of immobilized enzyme on nanostructured high-surface-area titanium electrodes instead of gold electrodes. The above-described electrodeposition process is used to form the titanium nanowires in a manner identical to the method used to form the gold nanowires. All of the electrical and operational properties of the third embodiment of the present invention are similar to those of the first embodiment of the present invention.

In a fourth embodiment of the present invention, the nanowires or carbon nanotubes of the first, second and third embodiments, along with the adjacent surface anode and cathode electrodes are coated with spherical biocolloidal substrates containing immobilized glucose oxidase and immobilized laccase, respectively, using a modified Langmuir-Blodgett lift-off process. Using this process, one or more thin layers of biocolloidal substrates are deposited onto the nanowires or carbon nanotubes and adjacent surface of each electrode, resulting in the precise construction of an enzyme architecture with control at the molecular level, while increasing the reactive surface area by one to two orders of magnitude over the first, second, or third embodiments.

As stated above in connection with the first embodiment of the present invention, the reaction rates determine the amount of power generated by the fuel cell. These rates depend primarily on the total reactive surface area of the anode and cathodes and the concentration of glucose and oxygen inside the cell. In the fourth embodiment of the present invention, the reactive surface area and the total available power generated by the electrochemical cell are both increased by one to two orders of magnitude.

The first, second, third, or fourth embodiments of the present invention may also include two or more electrochemical cells connected in series to generate higher voltages.

The first, second, third, or fourth embodiments of the present invention may further include two or more electrochemical cells connected in a series-parallel configuration for generating higher voltages and currents.

Further features and advantages of the present invention will be appreciated by a review of the following detailed description of the preferred embodiments taken in conjunction with the following drawings.

### BRIEF DESCRIPTION OF THE DRAWINGS

The present invention may be best understood by referring to the following detailed description of the preferred embodiments and the accompanying drawings, wherein like numerals denote like elements and in which:

FIG. 1A is a first configuration of a single electrochemical cell 100 constructed in accordance with the principles of the present invention;

FIG. 1B is a second configuration of a single electrochemical cell 150 constructed in accordance with the principles of the present invention;

FIGS. 2A and 2B show the steps of a process 200 for fabricating arrays of gold or titanium nanostructured rods 106, 108, 156, and 158, using electrodeposition in accordance with the present invention;

FIGS. 3A and 3B show the steps of a process 300 for fabricating arrays of carbon nanotubes 106, 108, 156, and 158, using chemical vapor deposition in accordance with the present invention;

FIG. 4 shows the steps of a first process 400 for forming the immobilized enzyme layers of the anode and cathode, in accordance with the first, second, and third embodiments of the present invention;

FIGS. 5A-5C show the steps of a second process 500 for forming immobilized enzyme layers, comprising biocolloidal substrates containing silica nanoparticles, of the anode and cathode, in accordance with the fourth embodiment of the present invention;

FIG. 6 is a functional schematic 600 showing the glucose oxidation and oxygen reduction reactions of electrochemical cell 100 of the present invention;

FIG. 7 is a functional schematic 700 of three electrochemical cells connected in series to provide an increased output voltage;

FIG. 8 is a functional schematic 800 of six electrochemical cells connected in series parallel to provide an increased output voltage and current; and

FIG. 9 is a functional schematic 900 of a complete bio-chip system with integrated power source, communicate module, sensor array, CPU control module, simulation array.

### DETAILED DESCRIPTION OF THE PREFERRED EMBODIMENTS

The following exemplary discussion focuses on a bio-implantable electrochemical cell system for providing high power for active implantable medical devices. The apparatus of the present invention provides an order of magnitude improvement in power density (1,000 to 10,000 μW cm⁻²) over existing glucose/oxygen fuel cells, with a total output power of 1,000 to 10,000 μW.

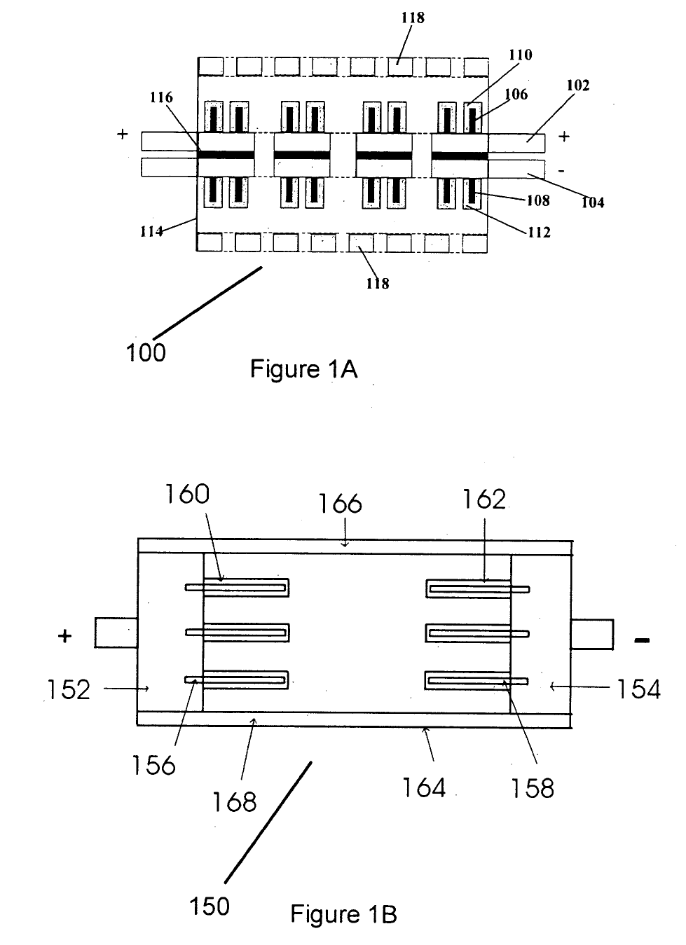

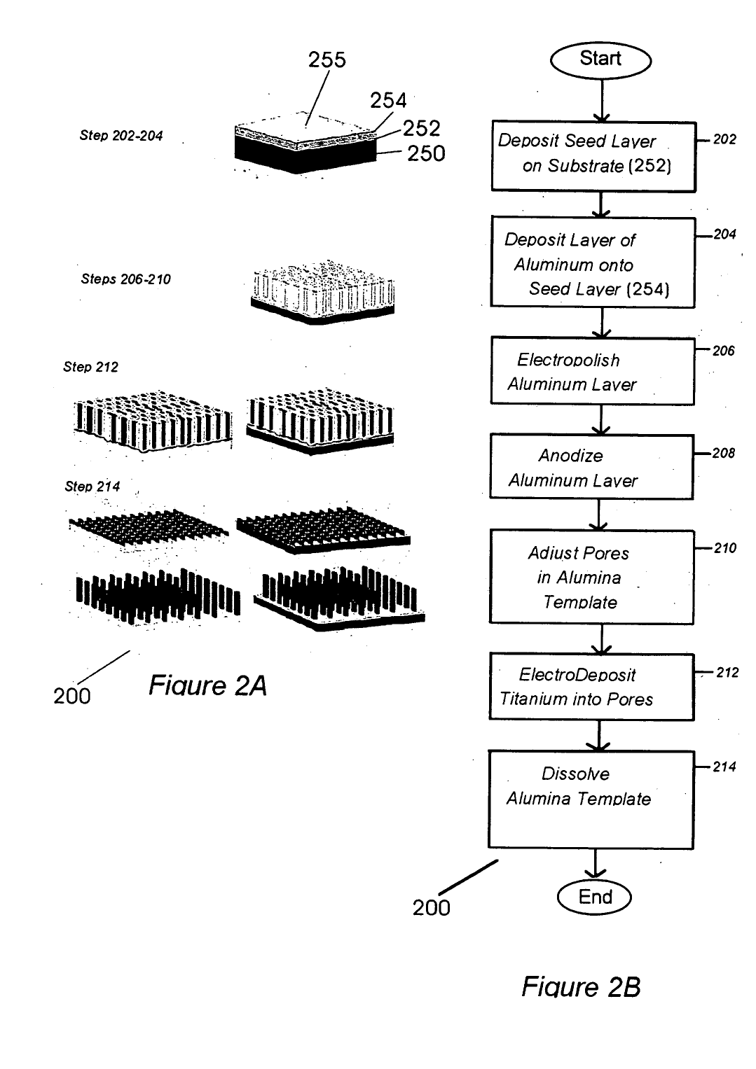

Referring to FIG. 1A, a first configuration of a single electrochemical cell 100 constructed in accordance with the principles of the present invention, is shown. Electrochemical cell 100 comprises an anode 102 and a cathode 104, both including arrays of nanostructured rods 106 and 108 in their respective interior portions. Immobile enzyme layers 110 and 112 are deposited on the interior surfaces of anode 102 and cathode 104, respectively, including on the arrays of nanostructured rods 106 and 108. Immobile enzyme layer 110 comprises glucose oxidase and is deposited on the interior surface and nanostructured rods of anode 102. Immobile enzyme layer 112 comprises laccase and is deposited on the interior surface and nanostructured rods of cathode 104.

In the preferred embodiments of the present invention, the dimensions of anode 102 and cathode 104 are four microns by four microns. The dimensions of each rod of nanostructured arrays 106 and 108 are two microns in height with a diameter of 500 angstroms, with each rod being composed of gold, titanium, or carbon nanotube. The thickness of the deposited immobilized enzyme layers is approximately 200 angstroms, or less.

Continuing with FIG. 1A, anode 102 and cathode 104 are positioned within a housing 114 in a side-by-side configuration, separated by an electrically insulating material 116 such as silicon dioxide. Housing 114 is constructed from an inert bio-compatible material such as teflon, and includes a porous membrane 118 on a side opposite anode 102 and cathode 104. Porous membrane 118 is designed to allow glucose and oxygen molecules to enter the interior of electrochemical cell 100, and to exclude all other macromolecules.

Referring now to FIG. 1B, a second configuration of a single electrochemical cell 150, is shown. Electrochemical cell 150 also comprises an anode 152 and a cathode 154, both including arrays of nanostructured rods 156 and 158 in their respective interior portions. As with electrochemical cell 100, an immobile enzyme layer 160 comprising glucose oxidase is deposited on the interior surface and nanostructured rods 156 of anode 152, and an immobile enzyme layer 162 comprising laccase is deposited on the interior surface and nanostructured rods 158 of cathode 154. The dimensions of anode 152 and cathode 154, along with nanostructured rods 156 and 158, are substantially similar to those of anode 102 and cathode 104 of electrochemical cell 100, discussed above.

In the configuration of electrochemical cell 150, anode 152 and cathode 154 are positioned within opposite ends of a housing 164. Housing 164 is constructed of an inert bio-compatible material such as teflon, and includes porous membranes 166 and 168 on two of its sides, opposite to each other and adjacent to anode 152 and cathode 154. Porous membranes 166 and 168 are designed to allow glucose and oxygen molecules to enter the interior of electrochemical cell 150, and to exclude all other macromolecules. The configuration of two porous membranes provides for an improved flow of glucose and oxygen across the arrays of nanostructured rods 156 and 158, compared to housing 114 of electrochemical cell 100.

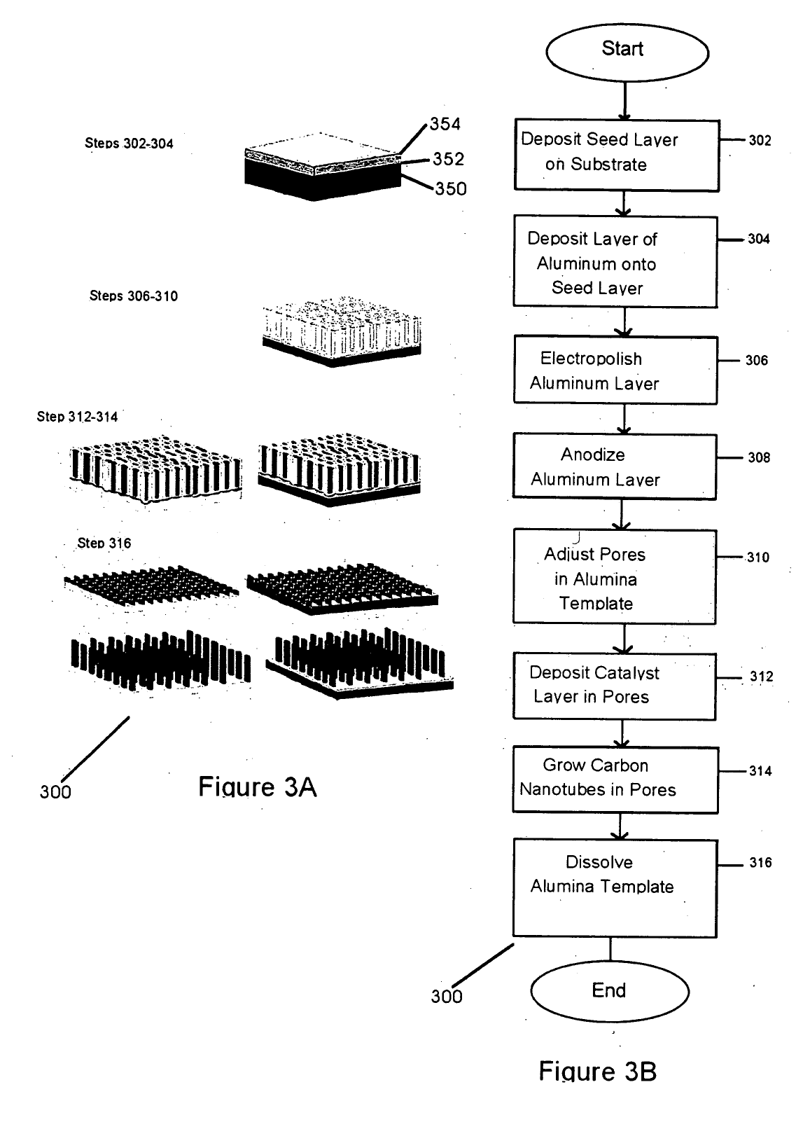

Continuing with FIGS. 2A and 2B, an electrodeposition process 200 for fabricating arrays of gold or titanium nanostructured rods 106, 108, 156, and 158 will now be disclosed. As shown in FIGS. 2A and 2B, process 200 begins with a step 202 of evaporating or sputtering a ten nanometer thick seed layer 252 of gold on a silicon substrate 250. Process 200 continues with a step 204 of evaporating or sputtering a two micron thick layer 254 of aluminum onto gold seed layer 252.

After layer 254 of aluminum is evaporated or sputtered onto gold seed layer 252, electrodeposition process 200 continues with steps 206-210. In step 206, a top surface 255 of aluminum layer 254 is electropolished with perchloric-ethanol and H₃PO₄-butanol to remove any surface defects. In step 208, aluminum layer 254 is anodized using H₂SO₄, H₃PO₄, mixed H₂SO₄/H₃PO₄, and oxalic acid. Anodizing step 208 converts aluminum layer 254 to porous alumina, whereby approximately 1,600 pores are produced during step 208. In step 210, the pores of alumina layer 254 are widened to an average approximate diameter of 500 angstroms using 0.2 M of H₃PO₄ which completes the anodizing process.

Continuing now with FIGS. 2A and 2B, electrodeposition process 200 continues with a step 212 of electrodepositing gold or titanium into the pores of alumina layer 254. Process 200 continues with a step 214 of dissolving alumina layer 254 by chemical etching, leaving the approximately 1,600 gold or titanium nanostructured rods attached to silicon substrate 250. As mentioned above, each nanostructured rod is approximately two microns in height and 500 angstroms in diameter.

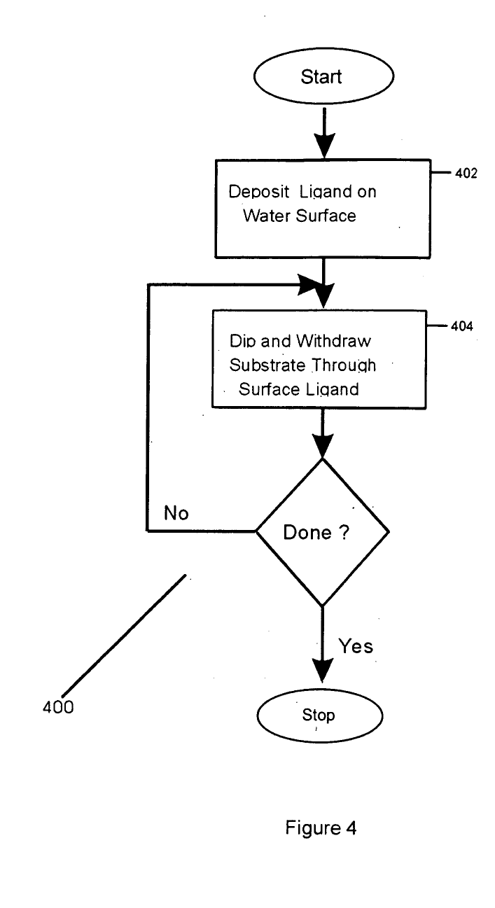

Referring now to FIGS. 3A and 3B, a chemical vapor deposition process 300 for fabricating arrays of carbon nanotube rods 106, 108, 156, and 158 will now be disclosed. As shown in FIGS. 3A and 3B, process 300 begins with a step 302 of evaporating or sputtering a ten nanometer thick seed layer 352 of gold on a silicon substrate 350. Process 300 continues with a step 304 of evaporating or sputtering a two micron thick layer 354 of aluminum onto gold seed layer 352.

After layer 354 of aluminum is evaporated or sputtered onto gold seed layer 352, a chemical vapor deposition process 300 continues with steps 306-310. In step 306, a top surface 355 of aluminum layer 354 is electropolished with perchloricethanol and H₃PO₄-butanol to remove any surface defects. In step 308, aluminum layer 354 is anodized using H₂SO₄, H₃PO₄, mixed H₂SO₄/H₃PO₄, and oxalic acid. Anodizing step 308 converts aluminum layer 354 to porous alumina, whereby approximately 1,600 pores are produced during step 308. In step 310, the pores of alumina layer 354 are widened to an average approximate diameter of 500 angstroms using 0.2 M of H₃PO₄ which completes the anodizing process.

Continuing now with FIGS. 3A and 3B, chemical vapor deposition process 300 continues with a step 312 of a catalyst layer of iron (Fe), cobalt (Co), or nickel (Ni) into the pores of alumina layer 354, followed by a step 314 of growing carbon nanotubes at 700° C. Process 300 continues with a step 316 of dissolving alumina later 354 by chemical etching, leaving the approximately 1,600 carbon nanotubes attached to silicon substrate 350. As mentioned above, each carbon nanotube is approximately two microns in height and 500 angstroms in diameter.

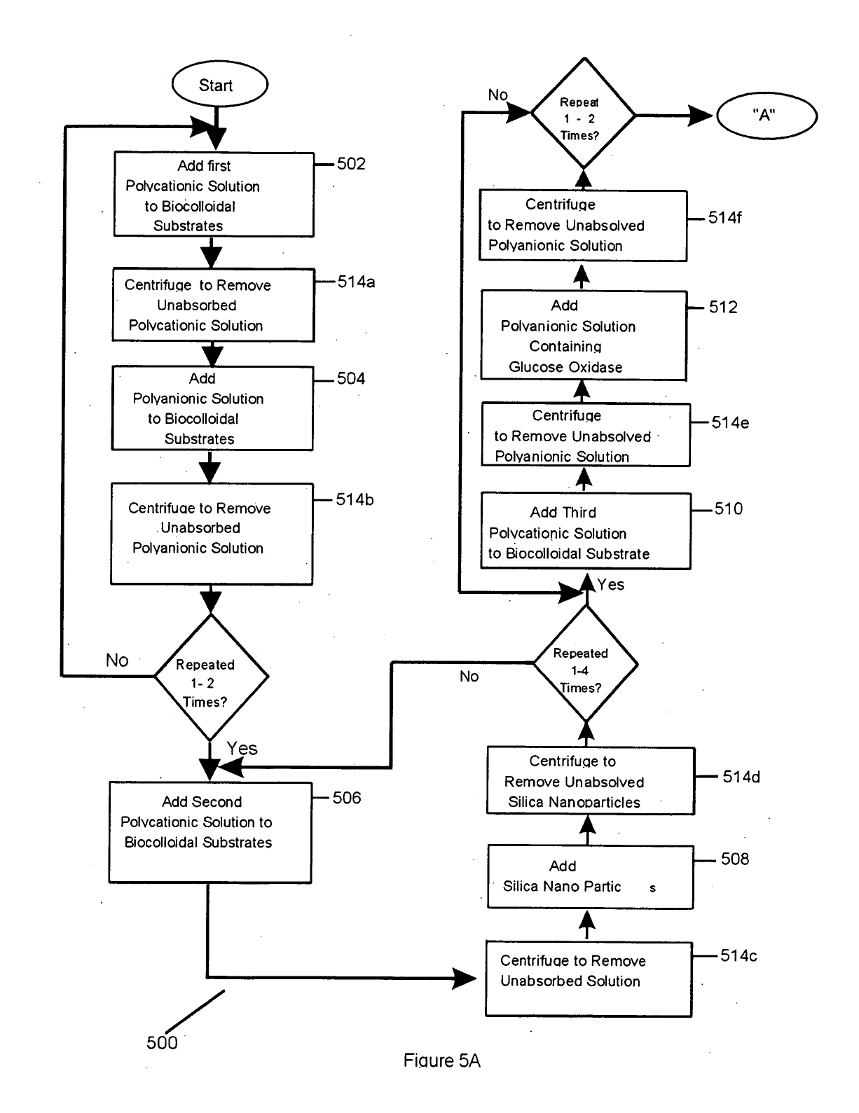

Continuing with FIG. 4, the steps of a first process 400 for forming and depositing immobilized enzyme layers 110, 112, 160, and 162 on anodes 102 and 152, and cathodes 104 and 154, in accordance with the first, second, and third embodiments of the present invention, are now disclosed. Process 400 is based on a conventional Langmuir-Blodgett process (See: Langmuir-Blodgett Films, edited by G. Roberts, Plenum, New York, 1990) for depositing monolayer organic films on a solid substrate that provides: (1) precise control of the monolayer thickness; (2) homogeneous deposition of the monolayer over large areas; and (3) the ability to build multi-layer structures with varying layer composition. An additional advantage of the Langmuir-Blodgett technique is that monolayers can be deposited on almost any type of substrate.

The Langmuir-Blodgett technique uses the surface free energy and surface tension properties of a liquid at the gas/liquid interface. In the particular case of a polar liquid such as water, there are strong intermolecular interactions and thus high surface tension. Any factor which decreases the strength of these interactions, especially the presence of surface active agents (surfactants), will lower the surface tension of the liquid.

Surfactants are amphiphilic molecules that consist of a hydrophilic (water soluble) and a hydrophobic (water insoluble) part. The hydrophilic part usually consists of a polar group and the hydrophobic part consists of hydrocarbon or fluorocarbon chains. The hydrocarbon or fluorocarbon chain has to be long enough to form an insoluble monolayer; otherwise, the amphiphiles on the water surface tend to form water soluble micelles that prevent build up of a monolayer. However, if the chain is too long the amphiphile tends to crystallize on the water surface, which again prevents the build up of a monolayer. Fortunately, a wide range of amphiphiles exist which lower the surface tension of water, and the amphiphilic nature of the molecules dictates the orientation of the molecules at the air/water interface.

When a solution of an amphipile in a water soluble solvent is placed on a water surface, the solution spreads rapidly to cover the available area. As the solvent evaporates, a monolayer is formed on the surface of the water. When the available area for the monolayer is large, the distance between adjacent amphiphilic molecules is large and their interactions are weak. This is referred to as the “gas phase” and in this phase the monolayer has very little effect on the surface tension of the water.

However, if the available surface area of the monolayer is reduced by a barrier system, the amphiphilic molecules begin to exert a repulsive force on each other and the monolayer transitions from the gas to a “liquid phase.” If the area is reduced further, the monolayer will eventually transition from the liquid to a “solid phase” in which the Langmuir-Blodgett technique is carried out. In the solid phase, the surface pressure is sufficiently high to ensure that the attraction between the monolayer molecules is high enough so that the monolayer does not fall apart during transfer to the solid substrate. This also ensures the build up of homogeneous multi-layers.

Note that the phase behavior of a specific amphiphile is determined by its physical and chemical properties, including temperature, the length of the hydrocarbon chain, and the magnitude of other cohesive and repulsive forces existing between the polar groups.

Referring again to FIG. 4, process 400 begins with a step 402 of depositing a solution containing one of immobile enzymes 110, 112 (glucose oxidase) or 160, 162 (laccase) on the surface of water contained in a teflon trough (not shown). The surface area of the water of controlled to maintain the monolayer in the solid phase by a pair of sweeping movable barriers (not shown) made of a hydrophilic material such as Delrin. Process 400 continues with a step 404 of successively dipping and withdrawing anodes 102 and 152, and cathodes 104 and 154 up and down through the enzyme monolayer while simultaneously maintaining a constant surface pressure by a computer-controlled feedback system. Since gold, titanium and carbon are hydrophobic, the first enzyme monolayer is deposited by lowering the anode or cathode into the water through the monolayer. As shown in FIG. 4, the first enzyme monolayer is adsorbed with the hydrocarbon chains toward the surface of anodes 102 and 152, and cathodes 104 and 154 in the down direction. Subsequent layers are formed by deposits in both the up and down directions, and in this way multi-layered structures of immobile enzymes 110, 112, 160, or 162 are produced.

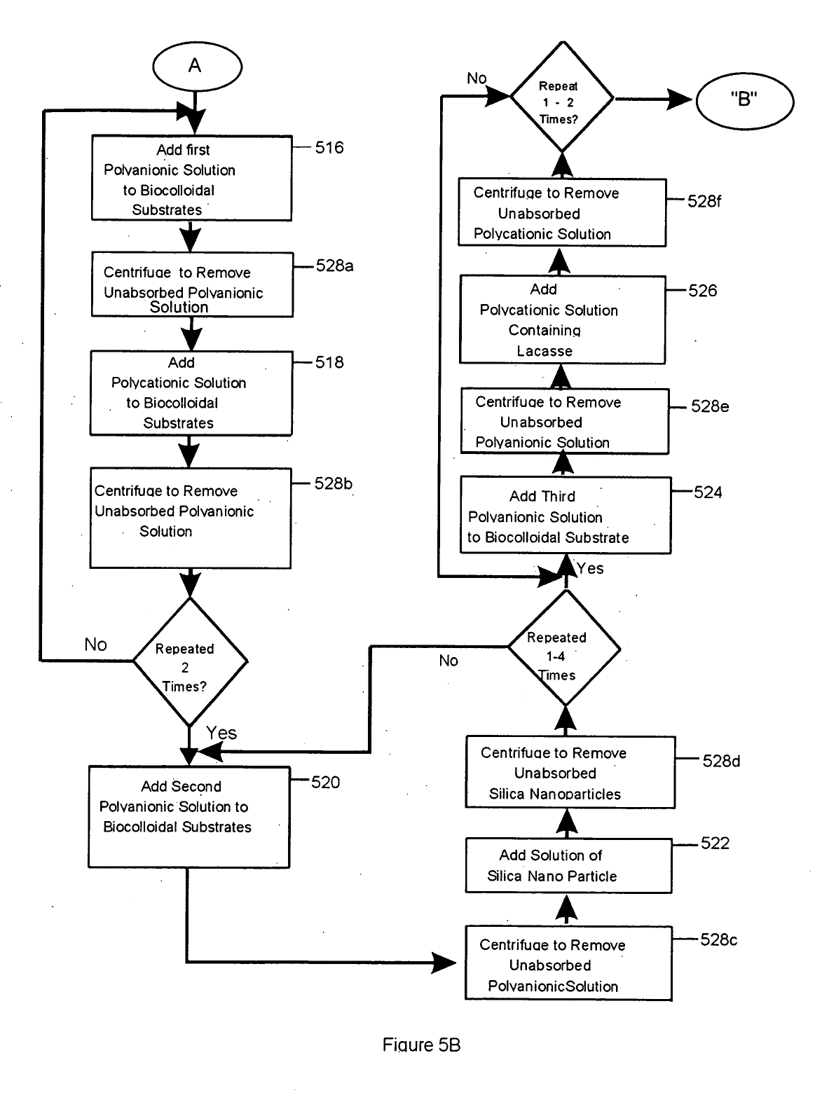

FIGS. 5A-5C show the exemplary steps of a second process 500 for forming and depositing immobilized enzyme layers 110, 112, 160, or 162 containing latex or other biocolloidal substrates and silica nanoparticles, on the surfaces and nanostructured rods of anodes 102 and 152, and cathodes 104 and 154. Process 500 begins with steps 502-528 of forming biocolloidal substrates containing silica nanoparticles and immobilized enzymes 110, 112 (glucose oxidase) or 160, 162 (laccase), using a modified layer-by-layer assembly process (See: M. Fang, P. Grant, M. McShane, G. Sukhorukov, V. Golub, Y. Lvov, Langmuir, 2002, v. 18, 6338-6344. “Magnetic Bio/Nanoreactor with Multilayer Shells of Glucose Oxidase and Inorganic Nanoparticles”). Steps 502-528 involve the stepwise growth of organized layers of oppositely charged polyelectrolytes, silica, and immobilized enzyme layers on biocolloidal substrates; for example, on latex spheres or carbon buckyballs, by alternately processing the substrates in polycation (positively charged) and polyanion (negatively charged) solutions. The inclusion of the silica layers yields a higher substrate surface area, resulting in greater enzyme adsorption and thereby increasing the catalytic activity of the immobilized enzyme. The deposition mechanisms in this process are electrostatic attraction, van der Waal forces, and capillary forces.

Continuing with FIG. 5A, steps 502-514 describing the formation of biocolloidal substrates containing organized layers of silica nanoparticles and glucose oxidase, are now described. Beginning with step 502, a first polycationic solution is added to a suspension of biocolloidal substrates until adsorption saturation. Biocolloidal substrates may comprise latex spheres or carbon buckyballs. In step 504, a polyanionic solution is added to the suspension of biocolloidal substrates until adsorption saturation. Steps 502 and 504 are performed twice. In step 506, a second polycationic solution is added to the suspension of biocolloidal substrates until adsorption saturation. In step 508, silica nanoparticles are added to the suspension of biocolloidal substrates until adsorption saturation. Steps 506 and 508 are performed one to four times. In step 510, a third polycationic solution is added to the suspension of biocolloidal substrates until adsorption saturation. In step 512, a polyanionic solution containing glucose oxidase is added to the suspension of biocolloidal substrates until adsorption saturation occurs. Steps 510-512 are performed once or twice. After each of steps 502-512, in a step 514 the coated biocolloidal substrates are separated from the unabsorbed species by centrifugation and the supernatant containing the unabsorbed species is removed. At this stage, the biocolloidal substrates are coated with up to four layers of silica nanoparticles and one or two layers of immobilized glucose oxidase with the following shell architectures:
{PEI/PSS}₂+{PEI/silica}₀₋₄+{PEI/GOₓ}₁₋₂.
where PEI is polyethyleneimine, PSS is polystyrenesulfonate.

Referring to FIG. 5B, steps 516-528 are now used to describe the formation of biocolloidal substrates containing organized layers of silica nanoparticles and laccase. In this case, the differences are the reversals of the polycationic and polyanionic solutions, and the substitution of laccase in place of glucose oxidase.

Beginning with step 516, a first polyanionic solution is added to a suspension of biocolloidal substrates until adsorption saturation. In step 518, a polycationic solution is added to the suspension of biocolloidal substrates until adsorption saturation. Steps 516 and 518 are performed twice. In step 520, a second polyanionic solution is added to the suspension of biocolloidal substrates until adsorption saturation. In step 522, silica nanoparticles are added to the suspension of biocolloidal substrates until adsorption saturation. Steps 520 and 522 are performed one to four times. In a step 524, a third polyanionic solution is added to the suspension of biocolloidal substrates until adsorption saturation. In step 526, a polycationic solution containing laccase is added to the suspension of biocolloidal substrates until adsorption saturation occurs. Steps 524 and 526 are performed one or two times. After each of steps 516-526, in a step 528 the biocolloidal substrates are separated from the unabsorbed species by centrifugation and the supernatant containing the unabsorbed species is removed. At this stage, the biocolloidal substrates are coated with up to four layers of silica nanoparticles and one or two layers of immobilized laccase with the following shell architectures:
{PSS/PEI}₂+{PSS/silica}₀₋₄+{PSS/laccase}₁₂.

Referring now to FIG. 5C, process 500 continues with a step 530 of depositing a solution, containing the biocolloidal substrates coated with silica nanoparticles and one of immobile enzymes 110, 112 or 160, 162, on the surface of water contained in a teflon trough (not shown). The surface area of the water of controlled to maintain the monolayer in the solid phase by a pair of sweeping movable barriers (not shown) made of a hydrophilic material such as Delrin. Process 500 continues with a step 532 of successively dipping and withdrawing anodes 102 and 152, and cathodes 104 and 154 up and down through the biocolloidal substrate monolayer while simultaneously maintaining a constant surface pressure by a computer-controlled feedback system. As discussed in connection with FIG. 4 and process 400, since gold, titanium and carbon are hydrophobic, the first biocolloidal substrate monolayer is deposited by lowering the anode or cathode into the water through the monolayer.

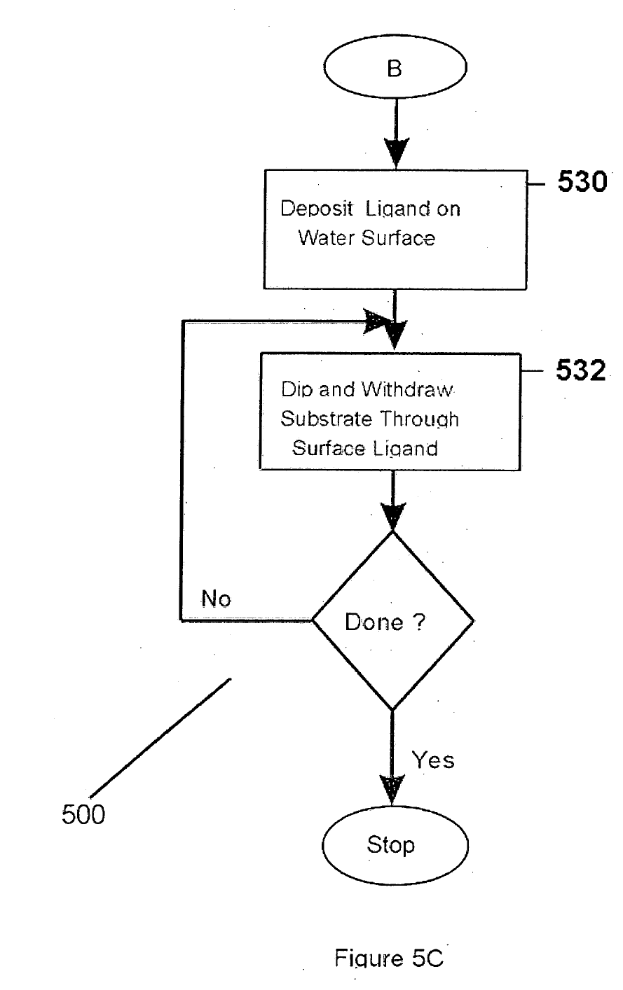

Referring now to FIG. 6, the glucose oxidation and oxygen reduction reactions of electrochemical cells 100 and 150 of the present invention, are now disclosed. A unit cell of this bio-fuel cell consists of two compartments 602 and 604. Individual compartment is made up of a porous membrane top layer 606, bio-compatible material coated side-walls 608, and a nanowire-based bottom layer 610 on a heavily-doped silicon substrate 612. A heavily-doped silicon substrate also has a number of pores 614 with a few hundred nanometer-size diameter. The nanowire-based cathode electrodes 616 and anode electrodes 618 are coated with glucose oxidase (GOx) enzymes 620 and laccase enzymes 622, respectively. Individual substrate 612 and 624 plays a role of conducting paths for electrons from nanowire-based cathodes 616 and anodes 610 to outside world 626 and 628, respectively. The back-side of substrates containing nanowire-based cathode 616 and anode 610 compartments are bonded together having an insulator layer 630 in between so glucose is diffused into the cell from both the top-porous membrane and the bottom-porous membrane. GOx-catalyzed oxidation of glucose at the anode is coupled with laccase-catalyzed oxygen reduction at the cathode in a miniature, non-compartmentalized system.

In electrochemical cells 100 and 150, glucose is oxidized by glucose oxidase (GOₓ) in a half-reaction at anode 610 or 152, respectively. Simultaneously, oxygen is reduced by laccase in a half-reaction at cathode 616 or 154, respectively. The following are the combined half-reactions:
Glucose→gluconolactone+2H⁺+2e⁻: cathode O₂+4H⁺+4e⁻→2H₂O: anode

More specifically, glucose oxidase catalyzes the oxidation of each molecule of β-D-glucose to D-gluconic acid and hydrogen peroxide. Since glucose oxidase is highly specific for β-D-glucose, it does not act on α-D-glucose; however, as a result of the consumption of β-D-glucose, α-D-glucose is converted into the β-form by mutarotation. The two electrons that are released by each glucose molecule from the nanowire-based cathode generating gluconolactone are used to perform electrical work through an external circuit.

Once the two electrons released by glucose oxidation with each glucose molecule have performed electrical work, laccase catalyzes the reduction of an oxygen molecule, four hydrogen nuclei and four electrons to form two water molecules. Laccase is a copper-containing phenyloxidase that requires a pH of 5.0 for optimal activity and stability; however, the pH of the human body is normally 7.2-7.4 so an effective system that operates at neutral pH is needed. This is accomplished in the present invention by using a pyrroloquinoline quinone (PQQ) mediated glucose oxidase system with tree-derived laccase.

A related issue is eliminating the need for membrane-separated anode and cathode compartments. In the present invention, this need is eliminated through effective coupling of the immobilized enzymes to the anode and cathode, so that very little glucose reacts at the cathode, and very little oxygen reacts at the anode.

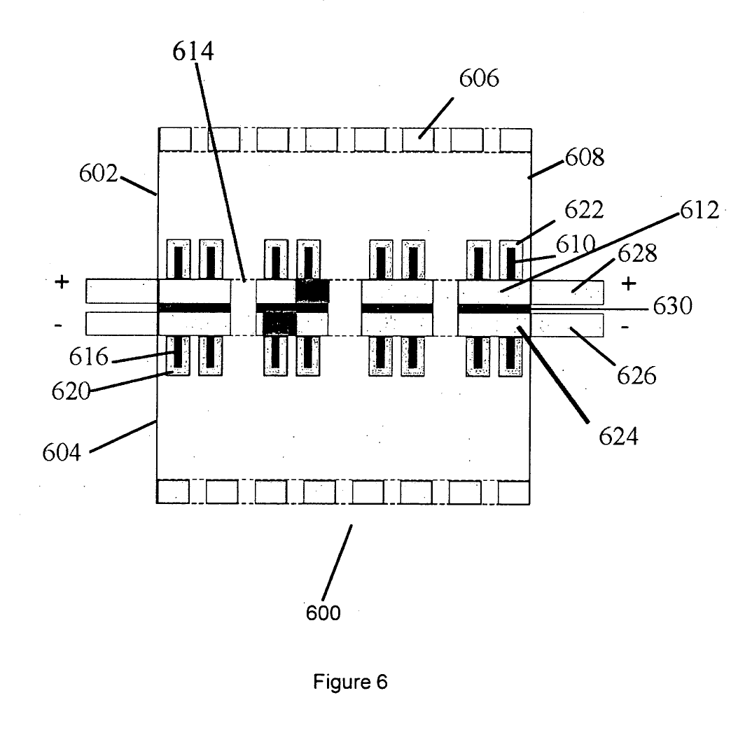

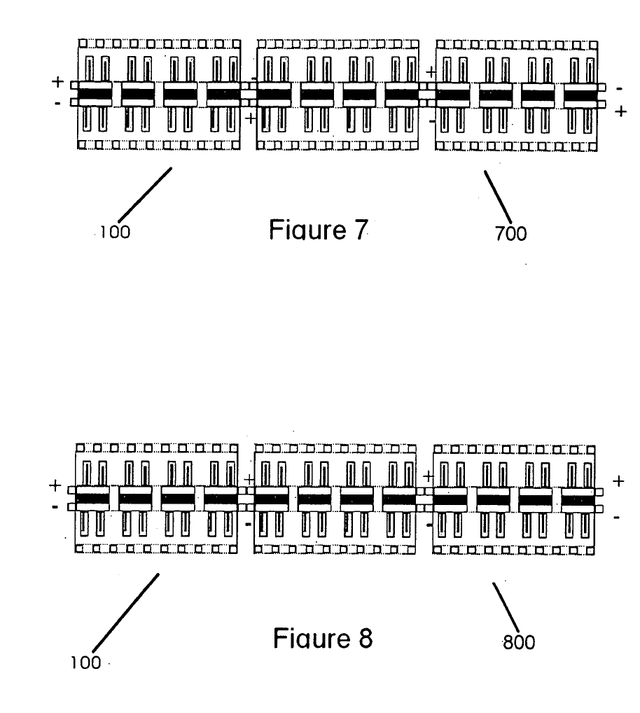

Continuing with FIGS. 7 and 8, functional schematics of three electrochemical cells connected in series 700 to provide an increase output voltage, and six electrochemical cells connected in series-parallel 800, are disclosed. As exemplified in FIG. 7, any number of cells may be connected in series to generate sufficient voltage to power active implanted medical devices. Similarly, as exemplified in FIG. 8, any number of cells may be connected in series-parallel to provide for the generation of sufficient voltage and current to power any type of active implantable medical device.

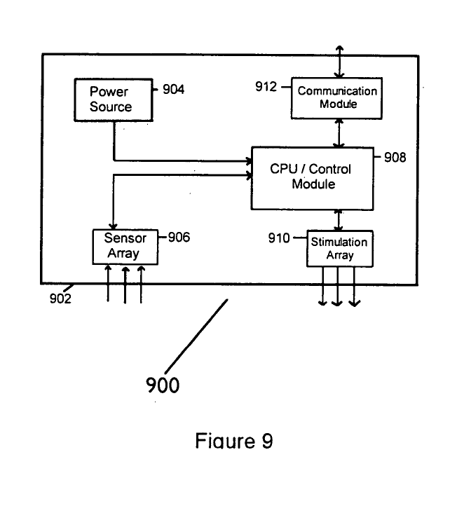

Referring now to FIG. 9, a functional schematic of an integrated implantable medical device 900 will now be discussed. Device 900 is an example of the type of single-chip, programmable devices that are possible using the electrochemical cell of the present invention, and may comprise a substrate 902 on which are fabricated a power source 904, a sensor array 906, a CPU/control module 908, a stimulation array 910, and a communication module 912.

For example, in one embodiment, device 900 may be programmed to function as a rate-adaptive cardiac pacemaker, in which sensor array 906 is configured to measure one or more parameters related to the physiologically correct value of the cardiac stimulation frequency. Such measured parameters may, for example, relate respiration with circulation activity to determine the physiologically correct stimulation frequency. CPU/control module 908 is programmed to establish the physiologically correct rate of the stimulation pulses, depending on the measured physiological parameters. Stimulation array 910 is then configured to generate stimulation pulses to the heart. Communication module 912 is configured to store and output calibration and control parameters to a receiver located external to the body.

Because device 900 includes electrochemical power source 904 and communication module 912 integrated on a common substrate 902, the device may be much smaller than existing implantable devices. In addition, since power source 904 does not require recharging, device 900 may be implanted essentially permanently.

The foregoing description includes what are at present considered to be preferred embodiments of the present invention. However, it will be readily apparent to those skilled in the art that various changes and modifications may be made to the embodiments without departing from the spirit and scope of the invention. For example, the exact dimensions of the electrochemical cell, the nanowires, or the carbon nanotubes may be changed. Alternatively, the precise dimensions, quantity, and composition of the biocolloidal substrates that are affixed to the anode and cathode may vary. Accordingly, it is intended that such changes and modifications fall within the spirit and scope of the invention, and that the present invention be limited only by the following claims.

1. An electrochemical cell for generating electrical energy from oxidation-reduction electron transfer, said electrochemical cell for use with active implantable medical devices, and said electrochemical cell comprising:
an anode having a first immobilized enzyme deposited on a first surface of said anode, said first immobile enzyme for catalyzing an electrooxidation of a reducing agent;
a cathode having a second immobilized enzyme deposited on a second surface of said cathode, said second enzyme for catalyzing an electroreduction of an oxidizing agent;
an aqueous solution containing said reducing agent and said oxidizing agent, said solution in contact with said first immobilized enzyme and said second immobilized enzyme; and
a housing for providing mechanical support and electrical separation of said anode and said cathode.

2. The electrochemical cell of claim 1 wherein said first immobilized enzyme comprises glucose oxidase.

3. The electrochemical cell of claim 2 wherein said glucose oxidase further comprises a plurality of biocolloidal substrates for increasing reactive surface area of said electrooxidation of said reducing agent.

4. The electrochemical cell of claim 1 wherein said second immobilized enzyme comprises laccase.

5. The electrochemical cell of claim 4 wherein said laccase further comprises a plurality of biocolloidal substrates for increasing reactive surface area of said electroreduction of said oxidizing agent.

6. The electrochemical cell of claim 2 wherein said reducing agent comprises glucose.

7. The electrochemical cell of claim 6 wherein said glucose oxidase further comprises a plurality of biocolloidal substrates for increasing reactive surface area of said electrooxidation of said glucose.

8. The electrochemical cell of claim 4 wherein said oxidizing agent comprises oxygen.

9. The electrochemical cell of claim 8 wherein said laccase further comprises a plurality of biocolloidal substrates for increasing reactive surface area of said electroreduction of said oxygen.

10. The electrochemical cell of claim 1 wherein said anode further comprises a plurality of nanostructured rods, said nanostructured rods attached vertically to said first surface of said anode.

11. The electrochemical cell of claim 10 wherein each of said plurality of nanostructured rods is comprised of gold.

12. The electrochemical cell of claim 10 wherein each of said plurality of nanostructured rods comprises titanium.

13. The electrochemical cell of claim 10 wherein each of said plurality of nanostructured rods comprises a carbon nanotube.

14. The electrochemical cell of claim 1 wherein said cathode further comprises a plurality of nanostructured rods, said nanostructured rods attached vertically to said second surface of said cathode.

15. The electrochemical cell of claim 14 wherein each of said plurality of nanostructured rods is comprised of gold.

16. The electrochemical cell of claim 14 wherein each of said plurality of nanostructured rods comprises titanium.

17. The electrochemical cell of claim 14 wherein each of said plurality of nanostructured rods comprises a carbon nanotube.

18. The electrochemical cell of claim 1 wherein said housing further comprises a biologically compatible material.

19. The electrochemical cell of claim 18 wherein said housing further comprises at least one permeable membrane for excluding macromolecules from said anode and said cathode of said electrochemical cell.

20. An electrochemical cell for generating electrical energy from oxidation-reduction electron transfer, said electrochemical cell for use with active implantable medical devices, and said electrochemical cell comprising:
an anode having an immobilized layer of glucose oxidase deposited on a first surface of said anode, said immobilized layer of glucose oxidase for catalyzing an electrooxidation of glucose;
a cathode having an immobilized layer of laccase deposited on a second surface of said cathode, said immobilized layer of laccase for catalyzing an electroreduction of oxygen;
an aqueous solution containing said glucose and said oxygen, said aqueous solution in contact with said glucose oxidase and said laccase; and
a housing for providing mechanical support and electrical separation of said anode and said cathode.

21. The electrochemical cell of claim 20 wherein said glucose oxidase further comprises a plurality of biocolloidal substrates for increasing reactive surface area of said electrooxidation of said glucose.

22. The electrochemical cell of claim 20 wherein said glucose oxidase further comprises a plurality of biocolloidal substrates for increasing reactive surface area of said electroreduction of said oxygen.

23. The electrochemical cell of claim 20 wherein said anode further comprises a plurality of nanostructured rods, said nanostructured rods attached vertically to said first surface of said anode.

24. The electrochemical cell of claim 23 wherein each of said plurality of nanostructured rods is comprised of gold.

25. The electrochemical cell of claim 23 wherein each of said plurality of nanostructured rods comprises titanium.

26. The electrochemical cell of claim 23 wherein each of said plurality of nanostructured rods comprises a carbon nanotube.

27. The electrochemical cell of claim 20 wherein said cathode further comprises a plurality of nanostructured rods, said nanostructured rods attached vertically to said second surface of said cathode.

28. The electrochemical cell of claim 27 wherein each of said plurality of nanostructured rods is comprised of gold.

29. The electrochemical cell of claim 27 wherein each of said plurality of nanostructured rods comprises titanium.

30. The electrochemical cell of claim 27 wherein each of said plurality of nanostructured rods comprises a carbon nanotube.

31. The electrochemical cell of claim 20 wherein said housing further comprises a biologically compatible material.

32. The electrochemical cell of claim 23 wherein said housing further comprises at least one permeable membrane for excluding macromolecules from said anode and said cathode of said electrochemical cell.

33. An electrochemical cell for generating electrical energy from oxidation-reduction electron transfer, said electrochemical cell for use with active implantable medical devices, and said electrochemical cell comprising:
an anode having an immobilized layer of glucose oxidase deposited on a first surface of said anode, said anode further comprising a plurality of nanostructured rods, said nanostructured rods attached vertically to said first surface of said anode, said immobilized layer of glucose oxidase for catalyzing an electrooxidation of glucose, and said immobile layer of glucose oxidase further comprising a plurality of biocolloidal substrates for increasing a reactive surface area of said electrooxidation of said glucose;
a cathode having an immobilized layer of laccase deposited on a second surface of said cathode, said cathode further comprising a plurality of nanostructured rods, said nanostructured rods attached vertically to said second surface of said cathode, said immobilized layer of laccase for catalyzing an electroreduction of oxygen, and said immobile layer of laccase further comprising a plurality of biocolloidal substrates for increasing reactive surface area of said electroreduction of said oxygen;
an aqueous solution containing said glucose and said oxygen, said aqueous solution in contact with said glucose oxidase and said laccase; and
a housing for providing mechanical support and electrical separation of said anode and said cathode, said housing having at least one permeable membrane for excluding macromolecules from said anode and said cathode of said electrochemical cell.

34. The electrochemical cell of claim 33 wherein each of said plurality of nanostructured rods is comprised of gold.

35. The electrochemical cell of claim 33 wherein each of said plurality of nanostructured rods comprises titanium.

36. The electrochemical cell of claim 33 wherein each of said plurality of nanostructured rods comprises a carbon nanotube.

37. The electrochemical cell of claim 33 wherein said housing further comprises a biologically compatible material.

38. In an electrochemical cell for generating electrical energy from electron transfer in an oxidation-reduction process, said electrochemical cell for use with active implantable medical devices, an electrode comprising:
a substrate having a top surface and a bottom surface;
a plurality of nanostructured rods, said plurality of nanostructured rods attached vertically to said top surface of said substrate; and
an immobilized enzyme layer deposited on said top surface of said substrate and on said plurality of nanostructured rods, said immobilized enzyme layer for catalyzing said oxidation-reduction process.

39. The electrode of claim 38 wherein each of said plurality of nanostructured rods is comprised of gold.

40. The electrode of claim 38 wherein each of said plurality of nanostructured rods comprises titanium.

41. The electrode of claim 38 wherein each of said plurality of nanostructured rods comprises a carbon nanotube.

42. The electrode of claim 38 wherein said immobilized enzyme layer further comprises a plurality of biocolloidal substrates for increasing a reactive surface area of said oxidation-reduction process.

43. In an electrochemical cell for generating electrical energy from electron transfer in an oxidation-reduction process, said electrochemical cell for use with active implantable medical devices, a method for fabricating an electrode comprising the steps of:
forming a substrate having a top surface and a bottom surface;
growing a plurality of nanostructured rods on said top surface of said substrate, said plurality of nanostructured rods oriented vertical to said top surface of said substrate; and
depositing an immobilized enzyme layer on said top surface of said substrate and on said plurality of nanostructured rods, said immobilized enzyme layer for catalyzing said oxidation-reduction process.

44. The method of claim 43 wherein said step of forming said substrate further comprises a step of depositing a seed layer of gold on said top surface of said substrate.

45. The method of claim 44 wherein said step of growing said plurality of nanostructured rods comprises a step of electrodeposition.

46. The method of claim 44 wherein said step of growing said plurality of nanostructured rods comprises a step of chemical vapor deposition.

47. The method of claim 43 wherein said step of depositing said immobilized enzyme layer further comprises the steps of:
forming a plurality of biocolloidal substrates for increasing a reactive surface area of said electrode; and
depositing said plurality of biocolloidal substrates on said top surface of said substrate and on said plurality of nanostructured rods.

48. An electrochemical cell comprising: an anode;
a first immobilized enzyme deposited on said anode, said first immobile enzyme for catalyzing an electrooxidation of a reducing agent;
a cathode;
a second immobilized enzyme deposited on said cathode, said second enzyme for catalyzing an electroreduction of an oxidizing agent; and
an aqueous solution containing said reducing agent and said oxidizing agent, said solution in contact with said first immobilized enzyme and said second immobilized enzyme.

49. A fuel cell comprising:
nanostructured metal nanowires or carbon nanotube electrodes; and
immobilized anode and cathode enzymes deposited on the nanowires or the electrodes.
